(19) United States
(12) Patent Application Publication
(10) Pub. No.: US 2012/0327020 A1
(43) Pub. Date: Dec. 27, 2012

(54) TOUCH PANEL-EQUIPPED DISPLAY DEVICE

(75) Inventors: Yasuhiro Kohara, Osaka-shi (JP); Akira Nakagawa, Osaka-shi (JP); Hidekazu Ohshima, Osaka-shi (JP); Tohru Sakata, Osaka-shi (JP)

(73) Assignee: SHARP KABUSHIKI KAISHA, Osaka-shi, Osaka (JP)

(21) Appl. No.: 13/579,108

(22) PCT Filed: Mar. 1, 2011
(86) PCT No.: PCT/JP2011/001172

§ 371 Date: Aug. 15, 2012

(30) Foreign Application Priority Data
Apr. 1, 2010 (JP) 2010-085198

(51) Int. Cl. G06F 3/044

(52) U.S. Cl. 345/174

(57) ABSTRACT

A touch panel-equipped display device (1) includes: a TFT substrate (2); a CF substrate (3) facing the TFT substrate (2); a liquid crystal layer (4) provided between the TFT substrate (2) and the CF substrate (3); a touch panel conductive film (6) provided on a surface (3a) of the CF substrate (3) opposite the liquid crystal layer (4); and a display region (D) including a transmissive region (Db) through which light (L) passes, and a non-transmissive region (Da) through which the light does not pass. The conductive film (6) includes a wire (6a), and an opening (6b) surrounded by the wire (6a) is formed in the conductive film (6). The wire (6a) is arranged in the non-transmissive region (Da), and the opening (6b) is formed in the transmissive region (Db).

### TECHNICAL FIELD

The present disclosure relates to a touch panel-equipped display device capable of detecting a position on a display surface touched by a pen or a finger.

### BACKGROUND ART

Touch panels (or touch sensors) which allow operation of electronic devices by touching a screen have been attached to the electronic devices, such as vending machines, ATMs, portable video games, car navigation systems, etc. The touch panel allows interactive input of information to the electronic device by touching (pressing) the panel with a finger or a pen.

The touch panels are classified into resistive touch panels, capacitive touch panels, infrared touch panels, ultrasonic touch panels, electromagnetic induction touch panels, etc., by their operating principles. The resistive and capacitive touch panels have commonly been used because they can be mounted on display devices at low costs. In particular, attention has been paid to the capacitive touch panels having high transmittance and high durability.

When the touch panel is integrally used with the display device, the touch panel is generally arranged on a front surface (a surface facing a viewer) of the display device, such as a liquid crystal display device. More specifically, as shown in FIG. 14, a liquid crystal display device 60 equipped with the resistive touch panel includes a thin-film transistor (TFT) substrate 50 as a first substrate, a color filter (CF) substrate 51 as a second substrate facing the viewer, and a liquid crystal layer 52 sandwiched between the TFT substrate 50 and the CF substrate 51. The liquid crystal display device 60 includes a transparent conductive film 53 for the touch panel provided as a resistive film on a surface of the CF substrate 51 opposite the liquid crystal layer 52, a transparent conductive film 54 for the touch panel provided as a resistive film facing the transparent conductive film 53, insulating spacers 55 sandwiched between a pair of transparent conductive films 53 and 54 to form an air layer between the pair of transparent conductive films 53 and 54, and a film (e.g., a polarizer) 56 arranged on the transparent conductive film 54 (see, e.g., Patent Document 1).

As shown in FIG. 14, the TFT substrate 50 includes a glass substrate 57, and a lower electrode 58 formed on the glass substrate 57. The CF substrate 51 includes a glass substrate 59, and an upper electrode 61 formed on the glass substrate 59. In the resistive touch panel configured in this way, the pair of transparent conductive films 53 and 54 are brought into contact (a short circuit occurs between the films) when a surface of the touch panel is pressed, and current flows between the pair of transparent conductive films 53 and 54. A pressed position on the surface is detected by sensing a change in voltage when the current has flowed between the pair of transparent conductive films 53 and 54 (i.e., a change in resistance).

In a display device equipped with the capacitive touch panel, instead of the transparent conductive films 53 and 54 and the spacers 55 described above, a transparent conductive film used as a transparent electrode of the capacitive touch panel is provided on a surface of the CF substrate 51 opposite the liquid crystal layer 52, and a polarizer is arranged on the transparent conductive film.

In the capacitive touch panel configured in this way, alternating voltage is applied to terminals for position detection arranged on the TFT substrate. When a contact point is formed on the transparent conductive film by a finger or a pen, the transparent conductive film is capacitively coupled to ground (a ground plane). A value of current flowing between the capacitively coupled contact point and the terminals is detected to obtain a position coordinate of the contact point.

### CITATION LIST

### Patent Document

[Patent Document 11 Japanese Patent Publication No. H05-108265

### SUMMARY OF THE INVENTION

### Technical Problem

In the liquid crystal display device 60 of Patent Document 1, the transparent conductive films 53 and 54 are provided on the entire surfaces of the liquid crystal display device 60. That is, the transparent conductive films 53 and 54 are present even in a region through which light passes. Thus, when the light passes the transparent conductive films 53 and 54, chromaticity of the light may disadvantageously change due to spectral characteristics of the transparent conductive films 53 and 54.

In addition, since the transparent conductive films 53 and 54 are provided in the region through which the light passes, transmittance of the light may disadvantageously be reduced when the light passes through the transparent conductive films 53 and 54.

In view of the foregoing, the present disclosure has been achieved. The present disclosure is concerned with providing a touch panel-equipped display device which can effectively prevent change of chromaticity of light, and reduction of transmittance of the light due to the conductive film.

### Solution to the Problem

In view of the above concern, the touch panel-equipped display device of the present disclosure includes: a first substrate; a second substrate facing the first substrate; a display medium layer provided between the first substrate and the second substrate; a conductive film for a touch panel provided on a surface of the second substrate opposite the display medium layer; and a display region including a transmissive region through which light passes, and a non-transmissive region through which the light does not pass, wherein the conductive film includes a wire, and an opening surrounded by the wire is formed in the conductive film, and the wire is arranged in the non-transmissive region, and the opening is formed in the transmissive region.

In this configuration, the wire is arranged in the non-transmissive region, and the opening is formed in the transmissive region. Thus, the wire does not block the light, and the light can pass through the opening. The wire of the conductive film arranged in the non-transmissive region can function as a conductive part, and the opening formed in the transmissive region can function as a transmissive part. This can effectively prevent change of chromaticity of the light and reduction of transmittance of the light due to the conductive film without impairing functions of the conductive film for the touch panel constituting the touch panel.

Since the opening is formed in the conductive film, an amount of a material used for forming the conductive film can be reduced, and costs can be reduced. The touch panel-equipped display device of the present disclosure may further include an interconnect formed in a frame region surrounding the display region, wherein the wire and the interconnect may be made of an identical material.

In this configuration, the conductive film and the interconnect can simultaneously be formed, and the number of fabrication steps can be reduced. This can improve yield of the display device, and can reduce fabrication costs.

In the touch panel-equipped display device of the present disclosure, the material may be a non-transparent conductive material.

In this configuration, there is no need to use indium tin oxide (ITO) which is expensive, and is generally used as the material of the transparent conductive film. Thus, the wire of the conductive film can be formed using a non-transparent conductive material which is inexpensive and versatile.

In the touch panel-equipped display device of the present disclosure, the conductive material may be at least one selected from a group consisted of gold, platinum, silver, copper, and aluminum.

Use of gold and platinum can improve resistance of the conductive film to corrosion. Use of silver can improve conductivity of the conductive film. Further, use of copper or aluminum can improve workability of the conductive film.

In the touch panel-equipped display device of the present disclosure, the material may be a transparent conductive material.

This configuration can reduce reflection of the light by the conductive material, and can alleviate reduction of display quality due to the light reflection.

In the touch panel-equipped display device of the present disclosure, the conductive material may be at least one selected from a group consisted of indium oxide, zinc oxide, tin oxide, and a transparent resin.

When indium oxide, zinc oxide, or tin oxide is used, a thin conductive film pattern can be formed. When the transparent resin is used, the conductive film and the interconnect can be formed by an inexpensive technique, such as printing.

In the touch panel-equipped display device of the present disclosure, a protective film may be provided on the surface of the second substrate opposite the display medium layer to cover the conductive film.

This configuration can improve mechanical durability of the display region (a coordinate input region) of the display device.

The touch panel-equipped display device of the present disclosure can effectively prevent the change of chromaticity of the light and the reduction of transmittance of the light due to the conductive film. Thus, the present disclosure can suitably be applied to a display device equipped with a capacitive touch panel. The capacitive touch panel attached to the display device may be a touch panel in which the conductive film is divided into a plurality of sections to allow multi-touch input. The present disclosure can suitably be applied to a display device equipped with a resistive touch panel. Further, the present disclosure can suitably be applied to a touch panel-equipped display device including a liquid crystal layer as the display medium layer.

### Advantages of the Invention

The present disclosure can effectively prevent the change of chromaticity of the light and the reduction of transmittance of the light due to the conductive film.

### BRIEF DESCRIPTION OF THE DRAWINGS

FIG. 1 is a cross-sectional view of a touch panel-equipped liquid crystal display device of a first embodiment of the present disclosure.

FIG. 2 is a plan view of the touch panel-equipped liquid crystal display device of the first embodiment of the present disclosure.

FIG. 3 is an enlarged view of part E in FIG. 2.

FIG. 4 is a plan view of the touch panel-equipped liquid crystal display device of the first embodiment of the present disclosure.

FIG. 5 is a cross-sectional view of a touch panel-equipped liquid crystal display device of a second embodiment of the present disclosure.

FIG. 6 is a partially enlarged view of the touch panel-equipped liquid crystal display device of the second embodiment of the present disclosure.

FIG. 7 is a plan view of an alternative of the touch panel-equipped liquid crystal display device of the present disclosure.

FIG. 8 is an enlarged view of part F in FIG. 7.

FIG. 9 is a cross-sectional view of an alternative of the touch panel-equipped liquid crystal display device of the present disclosure.

FIG. 10 shows an alternative of wires of the touch panel-equipped liquid crystal display device of the present disclosure.

FIG. 11 shows an alternative of the wires of the touch panel-equipped liquid crystal display device of the present disclosure.

FIG. 12 shows an alternative of the wires of the touch panel-equipped liquid crystal display device of the present disclosure.

FIG. 13 shows an alternative of the wires of the touch panel-equipped liquid crystal display device of the present disclosure.

FIG. 14 is a cross-sectional view of a conventional touch panel-equipped liquid crystal display device.

### DESCRIPTION OF EMBODIMENTS

### First Embodiment

Embodiments of the present disclosure will be described in detail with reference to the drawings. In the following embodiments, a liquid crystal display device will be described as an example of a display device.

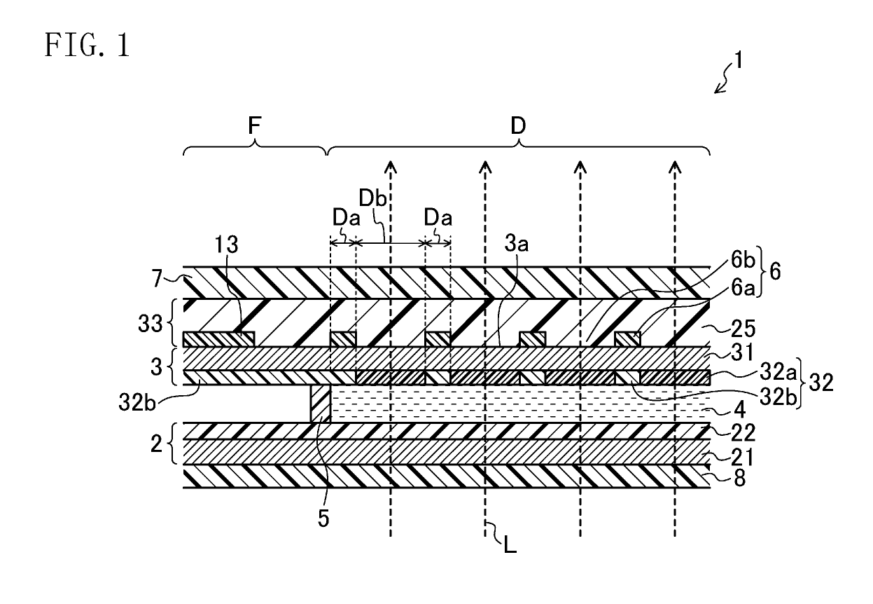

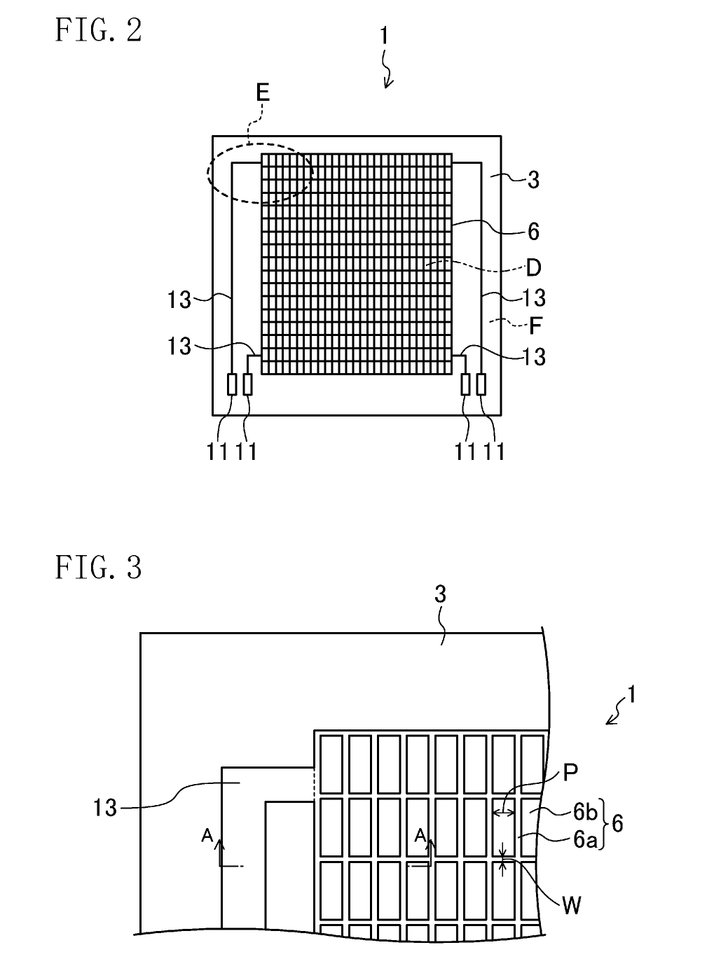

FIG. 1 is a cross-sectional view of a touch panel-equipped liquid crystal display device of a first embodiment of the present disclosure, and FIG. 2 is a plan view of the touch panel-equipped liquid crystal display device of the first embodiment of the present disclosure. FIG. 3 is an enlarged view of part E in FIG. 2. FIGS. 2 and 3 do not show a polarizer and a protective film for the sake of easy description. FIG. 1 is a cross-sectional view taken along the line A-A of FIG. 3.

As shown in FIGS. 1 and 2, a liquid crystal display device 1 includes a TFT substrate 2 which is a first substrate on which a plurality of thin-film transistors (TFTs) are formed as switching elements, and a CF substrate 3 which is a second substrate facing the TFT substrate 2. The liquid crystal display device 1 further includes a liquid crystal layer 4 which is a display medium layer sandwiched between the TFT substrate 2 and the CF substrate 3, and a frame-shaped sealing member 5 sandwiched between the TFT substrate 2 and the CF substrate 3 to bond the TFT substrate 2 and the CF substrate 3, and to seal the liquid crystal layer 4 therein.

The sealing member 5 is formed to surround the liquid crystal layer 4. The TFT substrate 2 and the CF substrate 3 are bonded to each other by the sealing member 5. Each of the TFT substrate 2 and the CF substrate 3 is in the shape of a rectangular plate. The liquid crystal display device 1 includes a plurality of photo spacers (not shown) for controlling a thickness of the liquid crystal layer 4 (i.e., a cell gap).

In the liquid crystal display device 1, as shown in FIGS. 1 and 2, a region which is inside the sealing member 5 and in which the TFT substrate 2 and the CF substrate 3 overlap each other is determined as a display region D which contributes to image display (a coordinate input region in which coordinate input through a touch panel is available).

A plurality of pixels, which are minimum units of an image, are arranged in a matrix pattern in the display region D. A frame region F in which the sealing member 5 is arranged is provided to surround the display region D.

Part of the TFT substrate 2 exposed from the CF substrate 3 (i.e., part of the TFT substrate 2 protruding from the CF substrate 3) is determined as a terminal region (not shown).

The liquid crystal display device 1 includes a touch panel conductive film 6 which is formed on a surface 3a of the CF substrate 3 opposite the liquid crystal layer 4, and constitutes a capacitive touch panel. The conductive film 6 constitutes the capacitive touch panel using an outer surface of a polarizer 7 formed on the conductive film 6 as a touch surface.

As shown in FIG. 1, a polarizer 8 is provided on a surface of the TFT substrate 2 opposite the liquid crystal layer 4.

The TFT substrate 2 includes an insulating substrate 21 such as a glass substrate, a TFT array layer 22 formed on the insulating substrate 21, and an alignment film (not shown) formed on the TFT array layer 22.

The TFT array layer 22 includes a plurality of gate lines (not shown) extending parallel to each other on the insulating substrate 21, a plurality of source lines (not shown) extending parallel to each other to be perpendicular to the gate lines, a plurality of TFTs (not shown) arranged at intersections of the gate lines and the source lines, and a plurality of pixel electrodes (not shown) connected to the TFTs.

The CF substrate 3 includes an insulating substrate 31 such as a glass substrate, a color filter layer 32 formed on the insulating substrate 31, an overcoat layer (not shown) formed on the color filter layer 32, a common electrode (not shown) formed on the overcoat layer, and an alignment film (not shown) formed on the common electrode.

The overcoat layer may not be formed, and the common electrode may directly be formed on the color filter layer 32.

The color filter layer 32 includes a plurality of color layers 32a each of which is colored red, green, or blue to correspond to the pixel electrodes on the TFT substrate 2, and a black matrix 32b provided between the color layers 32a.

The liquid crystal layer 4 may contain nematic liquid crystal having electro-optic properties.

The polarizers 7 and 8 are optical sheets capable of transmitting only a polarized component of incident light having a particular direction.

As shown in FIG. 2, the CF substrate 3 is provided with a plurality of terminals 11 (4 terminals in this embodiment) through which alternating voltage for position detection is supplied. The four terminals 11 are connected to four corners of the conductive film 6, respectively.

The terminals 11 are connected to a drive circuit chip (not shown) including an alternating voltage generator circuit provided on a flexible printed board (not shown) through an integrated circuit chip (not shown) provided in the terminal region on the TFT substrate 2. Alternatively, the terminals 11 may be connected to the drive circuit chip not through the integrated circuit chip, but through the flexible printed board connected to the integrated circuit chip via interconnects. The terminals 11 are electrically connected to an external power supply (not shown) through the flexible printed board. The terminals 11 are connected to the conductive film 6 through interconnects 13 as shown in FIG. 2.

In the present embodiment, the conductive film 6, the terminals 11, the interconnects 13, and a protective film 25 constitute a touch panel 33.

The liquid crystal display device 1 is provided with a backlight unit (not shown) which is arranged on a surface of the TFT substrate 2 opposite the liquid crystal layer 4 (i.e., a surface on which the polarizer 8 is formed), and supplies light (transmitted light) L to the liquid crystal display device 1.

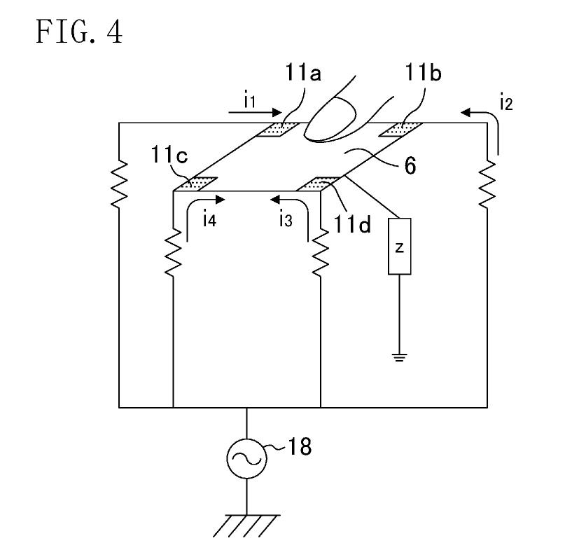

Referring to FIG. 4, a basic principle of position detection by the capacitive touch panel employed in the present disclosure will be described in brief. FIG. 4 is a plan view of the touch panel-equipped liquid crystal display device of the first embodiment of the present disclosure.

Terminals 11a, 11b, 11c, and 11d for position detection (corresponding to the above-described terminals 11) are connected to four corners of the conductive film 6 for position detection. Alternating voltage for position detection is supplied from an alternating voltage generator circuit 18 to the conductive film 6 through the terminals 11a, 11b, 11c, and 11d.

In this example, the alternating voltage generator circuit 18 is shared by the four terminals 11a, 11b, 11c, and 11d. However, the present disclosure is not limited to this example as long as alternating current of the same phase and potential can be applied. When at least two terminals are provided, a contact point between the terminals can be obtained.

A contact point is formed on the conductive film 6 when a pen or a finger touches or closely approaches a surface of the conductive film 6 of the touch panel-equipped liquid crystal display device 1, or a protective layer provided to face a viewer. In this specification, this event may be referred to as that the contact point is directly or indirectly formed on the conductive film 6.

When the contact point is formed on the conductive film 6, the conductive film 6 and ground (a ground plane) are capacitively coupled. The capacitive coupling is, for example, synthesis of capacity between the protective film 25 and the conductive film 6 and impedance between an operator and the ground (a ground plane).

Electrical resistance between the capacitively coupled contact point and each of the four terminals 11a, 11b, 11c, and 11d at the four corners of the conductive film 6 is proportional to a distance between the contact point and each terminal. Thus, current approximately inversely proportional to the distance between the contact point and each terminal flows through each of the four terminals 11a, 11b, 11c, and 11d at the four corners of the conductive film 6. A position coordinate of the contact point can be obtained by detecting magnitudes of the currents (relative ratio).

The currents flowing through the four corners of the conductive film 6 when the finger etc. touches the touch panel are referred to as i₁, i₂, i₃, and i₄, respectively (see FIG. 4). This example will be described on the premise that the current does not flow when the contact point is not formed on the conductive film 6. However, the current actually flows through stray capacitance even when the contact point is not formed. Thus, for the position detection, a change (an increment) of the current due to the formation of the contact point needs to be obtained.

For example, X and Y coordinates of the contact point on the conductive film 6 can be obtained by the following equations.

X=k₁+k₂·(i₂+i₃)/(i₁+i₂+i₃+i₄) (Equation 1)

Y=k₁+k₂·(i₁+i₂)/(i₁+i₂+i₃+i₄) (Equation 2)

The following equations may also be available.

X=k₁+k₂··i₂/(i₂+i₄)+i₃/(i₁+i₃)] (Equation 3)

Y=k₁+k₂·[i₁/(i₁+i₃)+i₂/(i₂+i₄)] (Equation 4)

In the equations, X is an X coordinate of the contact point on the conductive film 6, Y is a Y coordinate of the contact point on the conductive film 6, k₁ is an offset (0 when an output coordinate is an origin point), and k₂ is magnification. Symbols k₁ and k₂ designate constants which are independent from impedance of the operator.

Provided that a center of the coordinate input region is an origin point, Equations 1-4 can be represented as Equations 5-8.

X=k·(i₂+i₃−i₁−i₄)/(i₁+i₂+i₃+i₄) (Equation 5)

Y=k·(i₁+i₂−i₃−i₄)/(i₁+i₂+i₃+i₄) (Equation 6)

The following equations may also be available.

X=k·[(i₂−i₄)/(i₂+i₄)−(i₁−i₃)/(i₁+i₃)] (Equation 7)

Y=k·[(i₁−i₃)/(i₁+i₃)+(i₂+i₄)/(₂+i₄)] (Equation 8)

Thus, the contact point formed on the conductive film 6 can be obtained from measurements of the currents il, i2, i3, and i4 flowing through the four terminals 11a, 11b, 11c, and 11d. When the coordinates cannot be obtained with sufficient precision from these equations, higher-order correction calculation is performed as required.

In the present embodiment, as shown in FIGS. 1-3, the conductive film 6 includes wires 6a, openings 6b surrounded by the wires 6a are formed in the conductive film 6, and the conductive film 6 is in the shape of a net formed by the wires 6a. The wires 6a are arranged in a non-transmissive region Da (a region where the light L does not pass) of the display region D, and the openings 6b are formed in a transmissive region Db (a region where the light L passes) of the display region D.

More specifically, as shown in FIG. 1, the wires 6a of the conductive film 6 are arranged in the non-transmissive region Da (a region where the black matrix 32b is provided) of the display region D, and the openings 6b of the conductive film 6 are formed in the transmissive region Db (a region where the color layer 32a arranged between the black matrix 32b is provided) of the display region D.

In this configuration, as shown in FIG. 1, the wires 6a do not block the light L, and the light L can pass through the openings 6b. In the conductive film 6, the wires 6a arranged in the non-transmissive region Da can function as a conductive part, and the openings 6b formed in the transmissive region Db can function as a transmissive part.

Since the openings 6b are formed in the conductive film 6, an amount of a material used for forming the conductive film 6 can be reduced, and costs can be reduced.

In the present embodiment, the wires 6a of the conductive film 6 are made of the same material as the interconnects 13. Thus, the conductive film 6 and the interconnects 13 can simultaneously be formed, and the number of fabrication steps can be reduced.

The material for forming the wires 6a of the conductive film 6 and interconnects 13 does not need to be transparent, and a non-transparent conductive material (a metallic material) having conductivity can be used. This is because the wires 6a forming the conductive film 6 are arranged in the non-transmissive region Da of the display region D, and are not arranged in the transmissive region Db as described above.

The metallic material may be gold or platinum to improve resistance to corrosion. Silver may also be used to improve conductivity. Copper or aluminum may also be used to improve workability.

Use of the metallic material as the material for forming the wires 6a of the conductive film 6 eliminates the need to use indium tin oxide (ITO) which is generally used as the material of the transparent conductive film. Thus, the wires 6a of the conductive film 6 can be formed without using an expensive material.

The wires 6a of the conductive film 6 and the interconnects 13 may be made of a transparent conductive material. More specifically, the transparent conductive material may be a transparent inorganic material, such as indium oxide, zinc oxide, tin oxide, etc., or a transparent resin material.

When the transparent material is used, adverse effect on display quality can be reduced as compared with the case where the non-transparent material is used. Specifically, reflection of light by the conductive material can be reduced, and reduction in display quality due to the light reflection can be alleviated.

When the inorganic material such as indium oxide, zinc oxide, tin oxide, etc., is used, a thin pattern of the conductive film 6 can be formed. When the transparent resin material is used, the conductive film 6 and the interconnects 13 can be formed by an inexpensive technique, such as printing.

To improve the conductivity of the conductive film 6, the wires 6a of the conductive film 6 and the interconnects 13 are preferably made of a material having a surface resistance of 150Ω/□ or less.

A line width W and a pitch P of the wires 6a of the conductive film 6 are determined to correspond to a line width and a pitch of the black matrix 32b constituting the non-transmissive region Da of the display region D to ensure transmittance of the display region D. For example, the line width W of the wires 6a may be set to 5-50 μm, and the pitch P may be set to 20-500 μm.

The line width W of the wires 6a of the conductive film 6 is preferably increased as much as possible, and the pitch P is preferably decreased as much as possible to ensure the surface resistance of the wires 6a.

A method for fabricating the touch panel-equipped liquid crystal display device of the present embodiment will be described below. The method of the present embodiment includes fabrication of the TFT substrate, fabrication of the CF substrate, formation of the conductive film, and bonding of the substrates.

### (Fabrication of TFT Substrate)

For example, TFTs and pixel electrodes are formed on an insulating substrate 21 such as a glass substrate by patterning to form a TFT array layer 22 constituting a display region D. Then, a polyimide resin is applied on the entire surface of the substrate by printing, and the resin is rubbed to form an alignment film.

Then, spherical silica or plastic particles are scattered on the entire surface of the substrate to form spacers.

Thus, the TFT substrate 2 can be fabricated.

### (Formation of Conductive Film)

Then, a metal film of copper or aluminum is formed on a surface 3a of a CF substrate 3 (an insulating substrate 31) opposite a liquid crystal layer 4 by sputtering, and the metal film is patterned by photolithography and etching to form wires 6a. Thus, a conductive film 6 constituting a capacitive touch panel is formed on the surface 3a of the CF substrate 3 opposite the liquid crystal layer 4.

In this case, the conductive film 6 is in the shape of a net formed by the wires 6a as described above. The wires 6a of the conductive film 6 are arranged in a non-transmissive region Da (a region where the black matrix 32b is provided) of the display region D, and openings 6b of the conductive film 6 are formed in a transmissive region Db (a region where the color layer 32a arranged between the black matrix 32b is provided) of the display region D.

As described above, interconnects 13 are made of the same material as the wires 6a of the conductive film 6, and are simultaneously formed with the conductive film 6. Thus, as compared with the case where the conductive film 6 and the interconnects 13 are formed in different steps, the number of fabrication steps can be reduced.

The wires 6a of the conductive film 6 and the interconnects 13 may simultaneously be formed by printing metal paste made of a metallic material such as copper or aluminum by screen printing or ink jet printing, and patterning the metal paste.

Then, a protective film 25 is formed on the surface of the CF substrate 3 on which the conductive film 6 and the interconnects 13 are formed to cover the conductive film 6 and the interconnects 13. The protective film 25 is made of an organic or inorganic material. When the organic material is used, the protective film 25 may be formed by photolithography using a photosensitive material, printing, or ink jet printing. When the inorganic material is used, the protective film 25 may be formed by sputtering, and then patterned by wet or dry etching.

The provision of the protective film 25 can improve mechanical durability of the display region D (a coordinate input region) of the liquid crystal display device 1.

### (Fabrication of CF Substrate)

A color filter layer 32 including color layers 32a and a black matrix 32b, an overcoat layer, a common electrode, etc., are formed on the insulating substrate 31 by patterning to form a CF device layer constituting the display region D. Then, a polyimide resin is applied on the entire surface of the substrate by printing, and the resin is rubbed to form an alignment film. Thus, the CF substrate 3 is fabricated.

The black matrix 32b may be made of a metallic material, such as tantalum (Ta), chromium (Cr), molybdenum (Mo), nickel (Ni), titanium (Ti), copper (Cu), aluminum (Al), etc., a resin material in which black pigment, such as carbon, is dispersed, or a resin material including a stack of layers of different colors each having light transmittance.

### (Bonding of TFT Substrate and CF Substrate)

A frame-shaped sealing member 5 made of a UV/thermally curable resin etc. is formed on the CF substrate 3 using a dispenser, for example.

Then, liquid crystal is dropped onto a region inside the sealing member 5 formed on the CF substrate 3.

The CF substrate 3 on which the liquid crystal has been dropped and the TFT substrate 2 are bonded under reduced pressure.

Then, the bonded product is placed at an atmospheric pressure to apply pressure to front and rear surfaces of the bonded product. Then, UV light is applied to the sealing member 5 sandwiched between the bonded substrates, and the bonded product is heated to cure the sealing member 5.

A polarizer 7 is provided on a surface of the protective film 25 formed on the conductive film 6 and the interconnects 13, and a polarizer 8 is provided on a surface of the TFT substrate 2 opposite the liquid crystal layer 4. The above-described integrated circuit chip, which is an electronic component, is provided in a terminal region of the TFT substrate 2, and a flexible printed board is attached to the terminal region. Thus, the touch panel-equipped liquid crystal display device 1 shown in FIG. 1 is fabricated.

The present embodiment described above can provide the following advantages.

(1) In the present embodiment, the wires 6a constitutes the conductive film 6, and the openings 6b surrounded by the wires 6a are formed in the conductive film 6. The wires 6a are arranged in the non-transmissive region Da, and the openings 6b are formed in the transmissive region Db. Thus, the wires 6a do not block the light L, and the light L can pass through the openings 6b. The wires 6a of the conductive film 6 arranged in the non-transmissive region Da can function as a conductive part, and the openings 6b formed in the transmissive region Db can function as a transmissive part. Therefore, change of chromaticity of the light L and reduction of transmittance of the light L due to the conductive film 6 can effectively be prevented without impairing functions of the conductive film 6 constituting the touch panel.

(2) Since the openings 6b are formed in the conductive film 6, an amount of the material used for forming the conductive film 6 can be reduced, and costs can be reduced.

(3) In the present embodiment, the wires 6a and the interconnects 13 are made of the same material. Thus, the conductive film 6 and the interconnects 13 can simultaneously be formed, and the number of fabrication steps can be reduced. This can improve yield of the liquid crystal display device 1, and can reduce fabrication costs.

(4) In the present embodiment, a non-transparent conductive material is used as the material for forming the wires 6a of the conductive film 6. Thus, the wires 6a of the conductive film 6 can be formed by using a non-transparent metallic material which is inexpensive and versatile.

(5) In the present embodiment, gold, platinum, silver, copper, and aluminum can be used as the non-transparent conductive material for forming the wires 6a of the conductive film 6. This can improve resistance of the conductive film to corrosion, conductivity of the conductive film, and workability of the conductive film.

(6) In the present embodiment, a transparent conductive material is used as the material for forming the wires 6a of the conductive film 6. Thus, reflection of light by the conductive material can be reduced, and reduction in display quality due to the light reflection can be alleviated.

(7) In the present embodiment, indium oxide, zinc oxide, tin oxide, or a transparent resin can be used as the transparent conductive material for forming the wires 6a of the conductive film 6. When indium oxide, zinc oxide, or tin oxide is used, a thin pattern of the conductive film 6 can be formed. When the transparent resin is used, the conductive film 6 and the interconnects 13 can be formed by an inexpensive technique, such as printing.

(8) In the present embodiment, the protective film 25 is formed to cover the conductive film 6. This can improve mechanical durability of the display region D (the coordinate input region) of the liquid crystal display device 1.

### Second Embodiment

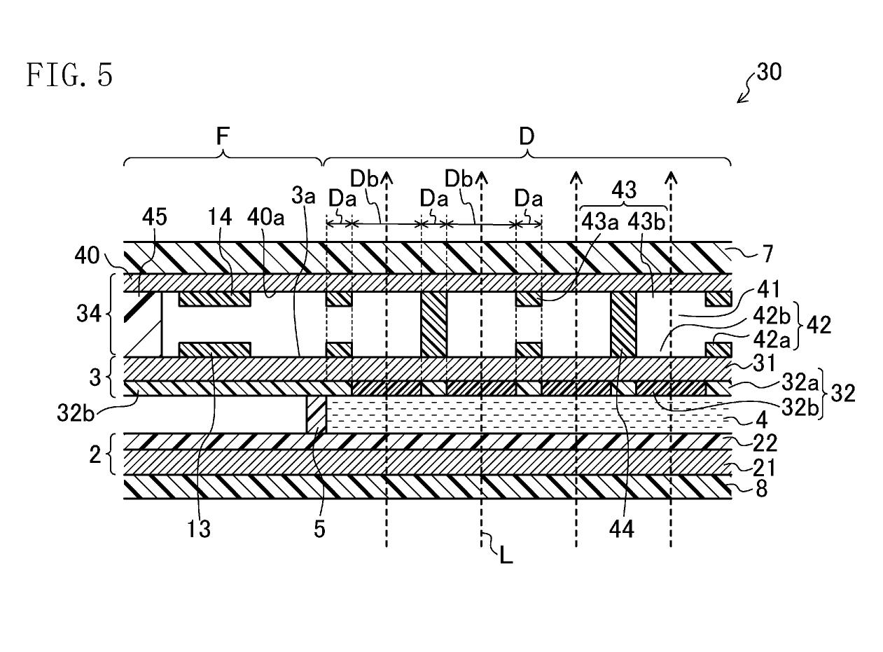

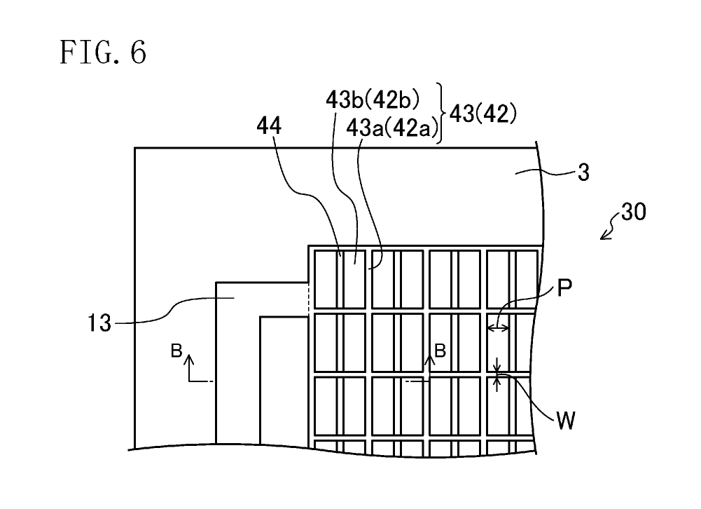

A second embodiment of the present disclosure will be described below. FIG. 5 is a cross-sectional view of a touch panel-equipped liquid crystal display device of a second embodiment of the present disclosure, and FIG. 6 is a partially enlarged view of the touch panel-equipped liquid crystal display device of the second embodiment of the present disclosure. FIG. 6 does not show a polarizer and a film substrate for the same of easy description. FIG. 5 is a cross-sectional view taken along the line B-B of FIG. 6. The same components as those of the first embodiment will be indicated by the same reference characters so that detailed description thereof can be omitted. A plan view of the touch panel-equipped liquid crystal display device is the same as that described in the first embodiment, and is not described in detail below.

A touch panel-equipped liquid crystal display device 30 of the present embodiment is a liquid crystal display device equipped with a resistive touch panel. As shown in FIG. 5, an insulating substrate 31 of a CF substrate 3 and a flexible film substrate 40 facing the insulating substrate 31 are arranged to sandwich an air layer 41 therebetween. The film substrate 40 may be made of a glass base, or a plastic base.

A touch panel conductive film 42 constituting the resistive touch panel is provided on a surface 3a of the CF substrate 3 opposite a liquid crystal layer 4. A touch panel conductive film 43 constituting the resistive touch panel is provided on a surface 40a of the film substrate 40 closer to the liquid crystal layer 4.

Like the conductive film 6 shown in FIG. 2, the conductive film 42 is connected to terminals 11 through interconnects 13. The film substrate 40 is provided with a plurality of terminals (not shown) to which alternating voltage for position detection is supplied, and the terminals are arranged at four corners of the conductive film 43, respectively. Like the conductive film 42, the conductive film 43 is connected to the terminals provided on the film substrate 40 through interconnects 14.

A plurality of dot spacers 44 are formed on the surface 3a of the CF substrate 3 opposite the liquid crystal layer 4 to protrude toward the air layer 41 so as to prevent erroneous contact between the conductive films 42 and 43 due to warpage of the film substrate 40 caused by an external factor.

The CF substrate 3 and the film substrate 40 are bonded to each other by a bonding member 45 provided in the air layer 41.

In the present embodiment, the film substrate 40, the conductive films 42 and 43, the dot spacers 44, the terminals, and the interconnects 13 and 14 constitute a touch panel 34 as shown in FIG. 5.

In the resistive touch panel configured in this way, the pair of conductive films 42 and 43 are brought into contact (a short circuit occurs between the films) when a surface of the film substrate 40 is pressed through the polarizer 7, and current flows between the pair of conductive films 42 and 43. A pressed position on the surface is detected by sensing a change in voltage (i.e., a change in resistance) when the current has flowed between the pair of conductive films 42 and 43.

In the present embodiment, as shown in FIGS. 5-6, the conductive film 42 includes wires 42a, openings 42b surrounded by the wires 42a are formed in the conductive film 42, and the conductive film 42 is in the shape of a net formed by the wires 42a, like the conductive film 6 described above. The wires 42a are arranged in a non-transmissive region Da of a display region D, and the openings 42b are formed in a transmissive region Db of the display region D.

Likewise, as shown in FIGS. 5-6, the conductive film 43 includes wires 43a, and openings 43b surrounded by the wires 43a are formed in the conductive film 43. The conductive film 43 is in the shape of a net formed by the wires 43a. The wires 43a are arranged in the non-transmissive region Da of the display region D, and the openings 43b are formed in the transmissive region Db of the display region D.

More specifically, as shown in FIG. 5, the wires 42a and 43a of the conductive films 42 and 43 are arranged in the non-transmissive region Da (a region where the black matrix 32b is provided) in the display region D, and the openings 42b and 43b of the conductive films 42 and 43 are formed in the transmissive region Db (a region where the color layer 32a arranged between the black matrix 32b is provided) of the display region D.

In this configuration, the wires 42a and 43a do not block light L, and the light L can pass through the openings 42b and 43b as shown in FIG. 5. In the conductive films 42 and 43, the wires 42a and 43a arranged in the non-transmissive region Da can function as a conductive part, and the openings 42b and 43b formed in the transmissive region Db can function as a transmissive part.

Since the openings 42b and 43b are formed in the conductive films 42 and 43, an amount of a material used for forming the conductive films 42 and 43 can be reduced, and costs can be reduced.

In the present embodiment, as shown in FIG. 5, the dot spacers 44 are arranged in the non-transmissive region Da of the display region D in the openings 42b of the conductive film 42. The openings 42b in the conductive film 42 except for the openings 42b in which the dot spacers 44 are arranged (the non-transmissive region Da where the dot spacers are arranged) are arranged in the transmissive region Db of the display region D.

Likewise, the openings 43b in the conductive film 43 except for the openings 43b in which the dot spacers 44 are arranged are arranged in the transmissive region Db of the display region D.

In the present embodiment, in the same manner as the first embodiment described above, the wires 42a of the conductive film 42 are made of the same material as the interconnects 13. Likewise, the wires 43a of the conductive film 43 are made of the same material as the interconnects 14.

Thus, the conductive film 42 and the interconnects 13 can simultaneously be formed, and the conductive film 43 and the interconnects 14 can simultaneously be formed. This can reduce the number of fabrication steps.

The material for forming the wires 42a and 43a of the conductive films 42 and 43 and the interconnects 13 and 14 may be the same as the material for forming the conductive film 6 of the first embodiment. A surface resistance of the conductive films may be determined in the same manner as described in the first embodiment. A line width and a pitch of the wires 42a and 43a of the conductive films 42 and 43 may be determined in the same manner as described in connection with the conductive film 6 of the first embodiment.

An example of a method for fabricating the touch panel-equipped liquid crystal display device of the present embodiment will be described below. The method of the present embodiment includes fabrication of the TFT substrate, fabrication of the CF substrate, formation of the conductive film, and bonding of the substrates. The fabrication of the TFT substrate, the fabrication of the CF substrate, and the bonding of the TFT substrate and the CF substrate are the same as those described in the first embodiment, and they will not be described in detail below.

### (Formation of Conductive Film)

After the fabrication of the CF substrate 3, a metal film of copper or aluminum is formed on a surface 3a of the CF substrate 3 opposite the liquid crystal layer 4 by sputtering. Then, the metal film is patterned by photolithography and etching to form wires 42a. Thus, a touch panel conductive film 42 constituting the resistive touch panel is formed on the surface 3a of the CF substrate 3 opposite the liquid crystal layer 4.

In this step, the conductive film 42 is in the shape of a net formed by the wires 42a as described above. The wires 42a of the conductive film 42 are arranged in a non-transmissive region Da (a region where the black matrix 32b is provided) of the display region D, and openings 42b of the conductive film 42 are formed in a transmissive region Db (a region where the color layer 32a arranged between the black matrix 32b is provided) of the display region D.

As described above, interconnects 13 are made of the same material as the wires 42a of the conductive film 42, and are simultaneously formed with the conductive film 42. Thus, as compared with the case where the conductive film 42 and the interconnects 13 are formed in different steps, the number of fabrication steps can be reduced.

The wires 42a of the conductive film 42 and the interconnects 13 may simultaneously be formed by printing metal paste made of a metallic material such as copper or aluminum by screen printing or ink jet printing, and patterning the metal paste.

Then, a film substrate 40 made of polypropylene, polyethylene, or polyethylene terephthalate, etc., is prepared, and a metal film made of copper or aluminum is formed on a surface 40a of the film substrate 40 closer to the liquid crystal layer 4 by sputtering in the same manner as the formation of the conductive film 42. Then, the metal film is patterned by photolithography and etching to form wires 43a. Thus, a touch panel conductive film 43 constituting the resistive touch panel is formed on the surface 40a of the film substrate 40 closer to the liquid crystal layer 4.

In this step, as described above, the conductive film 43 is in the shape of a net formed by the wires 43a. Interconnects 14 are made of the same material as the wires 43a of the conductive film 43, and are simultaneously formed with the conductive film 43.

In this case, the wires 43a of the conductive film 43 and the interconnects 14 may simultaneously be formed by printing metal paste made of a metallic material such as copper or aluminum by screen printing or ink jet printing, and patterning the metal paste.

Then, dot spacers 44 made of a non-conductive resin material, such as an acrylic resin, are formed on the surface of the CF substrate 3 by photolithography.

### (Bonding of Substrates)

A frame-shaped bonding member 45 made of a resin material containing acrylic resin spacers (not shown) is formed on the CF substrate 3 using a dispenser, for example.

Then, the CF substrate 3 and the film substrate 40 are bonded to each other with the bonding member 45 interposed therebetween. In this step, the wires 43a of the conductive film 43 are arranged in the non-transmissive region Da of the display region D, and the openings 43b of the conductive film 43 are formed in the transmissive region Db of the display region D. Thus, the touch panel-equipped liquid crystal display device 1 shown in FIG. 5 is fabricated.

The present embodiment can provide advantages similar to the advantages (1)-(7) described above.

The above-described embodiments may be modified in the following manner.

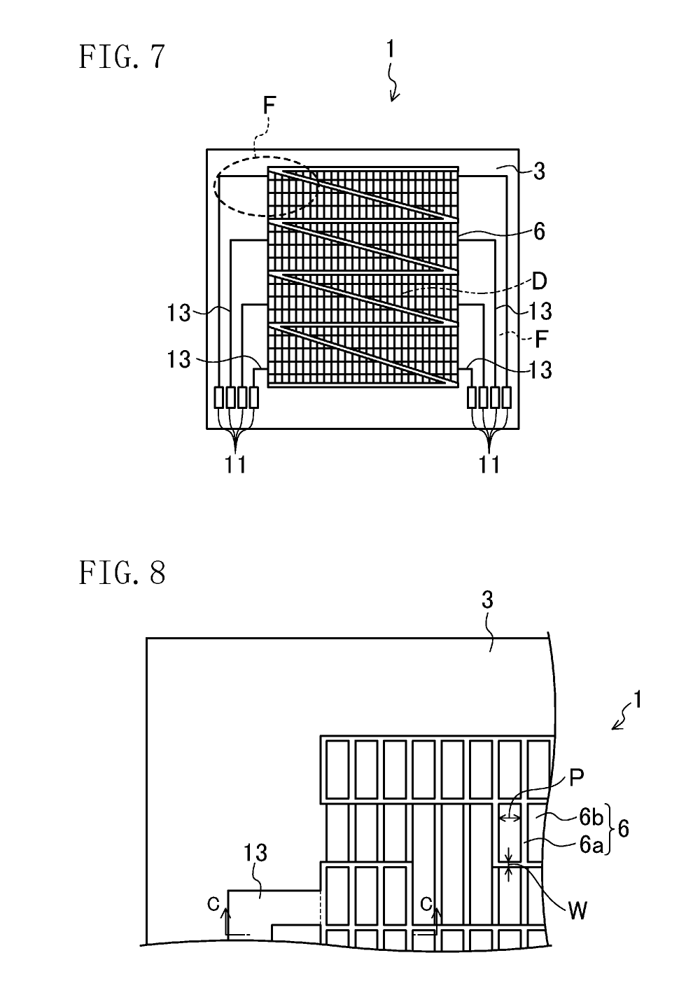

In the first embodiment, the touch panel-equipped liquid crystal display device 1 which allows single-touch input has been described as an example. However, the present disclosure is applicable to a touch panel-equipped liquid crystal display device 1 shown in FIGS. 7 and 8 in which the conductive film 6 constituting the capacitive touch panel is divided into a plurality of sections (8 sections in FIG. 7) to allow multi-touch input.

FIG. 8 is an enlarged view of part F in FIG. 7, and FIG. 1 is a cross-sectional view taken along the line C-C in FIG. 8. FIGS. 7 and 8 do not show the polarizer and the protective film for the same of easy description in the same manner as FIGS. 2 and 3.

In this case, as shown in FIG. 7, the terminals 11 are arranged to correspond to the divided sections of the conductive film 6, and the terminals 11 are connected to the divided sections of the conductive film 6 through the interconnects 13.

The multi-touch input is an input method which allows operation of an electronic device by simultaneously touching a plurality of points on a surface of the touch panel. In each of the divided sections of the conductive film 6, a plurality of contact points can be detected based on the basic principle of position detection by the capacitive touch panel described with reference to FIG. 4.

In the liquid crystal display device equipped with the multi-touch input touch panel, the wires 6a of the conductive film 6 are arranged in the non-transmissive region Da of the display region D, and the openings 6b of the conductive film 6 are formed in the transmissive region Db of the display region D. Thus, advantages similar to the advantages (1)-(8) described above can be obtained.

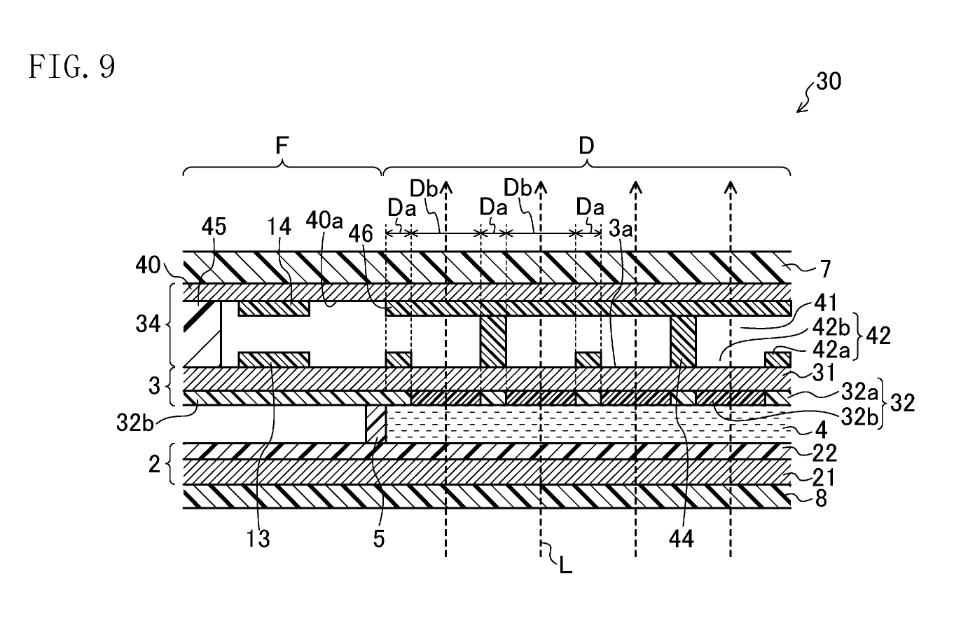

In the second embodiment, the resistive touch panel-equipped liquid crystal display device 30 has been described as an example. However, as shown in FIG. 9, the conductive film 43 described with reference to FIG. 5 may be replaced with a transparent conductive film 46 made of ITO etc., and only the conductive film 42 of the pair of conductive films 42 and 43 facing each other may include the wires 42a and the openings 42b may be formed therein.

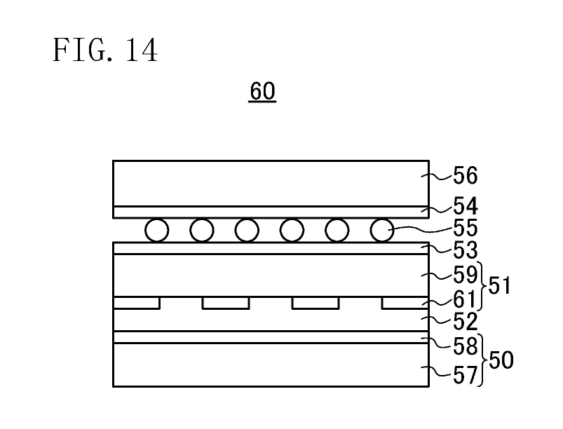

In this case, the touch panel transparent conductive film 46 which is formed on the surface 40a of the film substrate 40 closer to the liquid crystal layer 4, and constitutes the resistive touch panel is also arranged in the transmissive region Db of the display region D. Thus, when the light L passes through the transparent conductive film 46, chromaticity of the light may change, and transmittance of the light may be reduced. However, as compared with the conventional technique of providing the transparent conductive films 53 and 54 on the entire surfaces of the liquid crystal display device 60, frequency at which the light L passes through the transparent conductive film is reduced. Specifically, in the conventional liquid crystal display device shown in FIG. 14, the light passes through both of the transparent conductive films 53 and 54, i.e., the light passes twice through the transparent conductive film. In the liquid crystal display device 30 shown in FIG. 9, the light L passes through the transparent conductive film 46 only, i.e., the light passes only once through the transparent conductive film. Thus, the frequency at which the light L passes through the conductive film can be reduced.

This can reduce the change of chromaticity of the light L, and can alleviate the reduction of transmittance of the light L due to the conductive film as compared with the conventional liquid crystal display device.

In the embodiment described above, the conductive film 6 is in the shape of a net formed by the wires 6a. However, the wires 6a of the conductive film 6 may be arranged to correspond to the pattern of the non-transmissive region Da of the display region D to modify the pattern of the conductive film 6 as required.

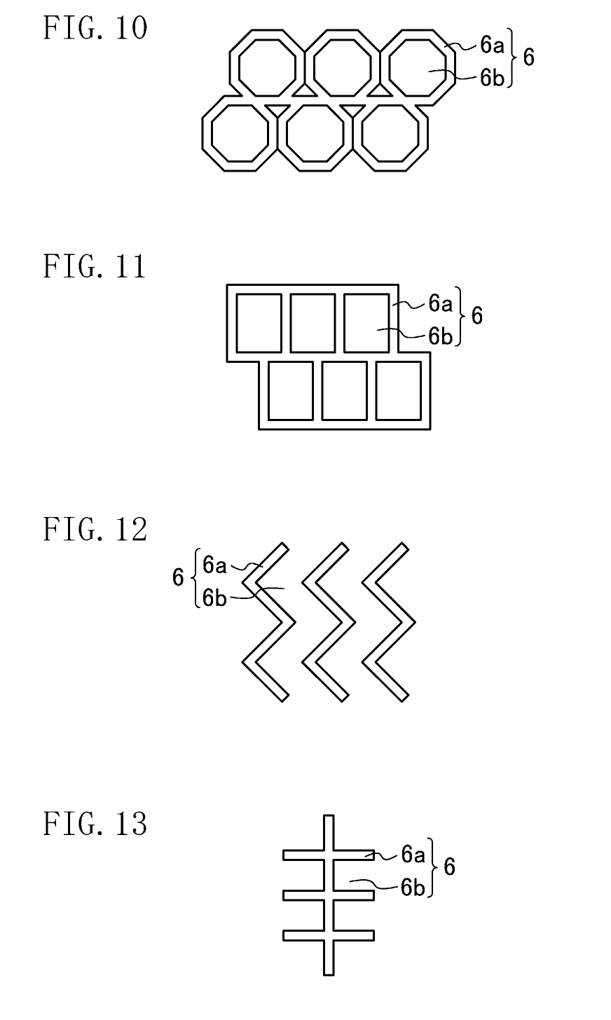

For example, as shown in FIG. 10, the wires 6a may be arranged to form substantially polygonal (substantially hexagonal) openings 6b. As shown in FIG. 11, the wires 6a may be arranged to form substantially polygonal (substantially quadrangular) openings 6b, and the openings 6b may be arranged in a delta array. In addition, the wires 6a may be zigzag-shaped, or may be comb-shaped as shown in FIGS. 12 and 13.

In the embodiments described above, the substrates are bonded after the formation of the conductive film. However, the TFT substrate 2 and the CF substrate 3 may be formed and bonded first, and then the conductive film may be formed after the bonding.

In the resistive touch panel-equipped liquid crystal display panel 30 shown in FIGS. 5 and 9, the protective film 25 may be provided on the surface 3a of the CF substrate 3 opposite the liquid crystal layer 4 to cover the conductive films 42 and 43. This configuration can provide the advantage similar to the advantage (8).

In the embodiments described above, the TFT liquid crystal display device has been described as an example of the display device. However, the present disclosure is applicable to different display devices, such as DUTY liquid crystal display devices, polysilicon liquid crystal display devices, organic electro luminescence (EL) display devices, plasma display devices, electronic paper, etc.

### INDUSTRIAL APPLICABILITY

As described above, the present disclosure is particularly useful for a display device equipped with a capacitive or resistive touch panel.

### Description of Reference Characters

1 Touch panel-equipped liquid crystal display device
2 TFT substrate (first substrate)
3 CF substrate (second substrate)
3a Surface of the CF substrate opposite a liquid crystal layer
4 Liquid crystal layer (display medium layer)
5 Sealing member
6 Touch panel conductive film
6a Wire
6b Opening
7 Polarizer
8 Polarizer
11 Terminal
13 Interconnect
25 Protective film
30 Touch panel-equipped liquid crystal display device
32 Color filter layer
32a Color layer
32b Black matrix
33 Touch panel
34 Touch panel
42 Touch panel conductive film
42a Wire
42b Opening
43 Touch panel conductive film
43a Wire
43b Opening
44 Dot spacer
46 Transparent conductive film
D Display region
Da Non-transmissive region
Db Transmissive region
F Frame region
L Light

1. A touch panel-equipped display device, comprising:
a first substrate;
a second substrate facing the first substrate;
a display medium layer provided between the first substrate and the second substrate;
a conductive film for a touch panel provided on a surface of the second substrate opposite the display medium layer; and
a display region including a transmissive region through which light passes, and a non-transmissive region through which the light does not pass, wherein
the conductive film includes a wire, and an opening surrounded by the wire is formed in the conductive film, and
the wire is arranged in the non-transmissive region, and the opening is formed in the transmissive region.

2. The touch panel-equipped display device of claim 1, further comprising:
an interconnect formed in a frame region surrounding the display region, wherein
the wire and the interconnect are made of an identical material.

3. The touch panel-equipped display device of claim 2, wherein
the material is a non-transparent conductive material.

4. The touch panel-equipped display device of claim 3, wherein
the conductive material is at least one selected from a group consisted of gold, platinum, silver, copper, and aluminum.

5. The touch panel-equipped display device of claim 2, wherein
the material is a transparent conductive material.

6. The touch panel-equipped display device of claim 5, wherein
the conductive material is at least one selected from a group consisted of indium oxide, zinc oxide, tin oxide, and a transparent resin.

7. The touch panel-equipped display device of claim 1, wherein
a protective film is provided on the surface of the second substrate opposite the display medium layer to cover the conductive film.

8. The touch panel-equipped display device of claim 1, wherein
the touch panel is a capacitive touch panel.

9. The touch panel-equipped display device of claim 8, wherein
the conductive film of the touch panel is divided into a plurality of sections to allow multi-touch input.

10. The touch panel-equipped display device of claim 1, wherein
the touch panel is a resistive touch panel.

11. The touch panel-equipped display device of claim 1, wherein
the display medium layer is a liquid crystal layer.
